(19) United States
(12) Patent Application Publication
(10) Pub. No.: US 2003/0150176 A1
(43) Pub. Date: Aug. 14, 2003

(54) Glass panel systems and methods of providing glass panel systems

(75) Inventor: Jonathan Coalson, Rifle, CO (US)

Correspondence Address: SANTANGELO LAW OFFICES, P.C., 125 SOUTH HOWES, THIRD FLOOR, FORT COLLINS, CO, 80521, US

(73) Assignee: Avalanche Glass, Inc., Silt, CO

(21) Appl. No.: 10/335,969

(22) Filed: Dec. 31, 2002

Related U.S. Application Data
(60) Provisional application No. 60/347,084, filed on Dec. 31, 2001.

(51) Int. Cl. E06B 3/32; E06B 3/00

(52) U.S. Cl. 52/204.51; 52/204.58

(57) ABSTRACT

A glass panel system that provides nearly transparent enclosure of a desired area. Specifically, at least one glass support element that may be used with a variety of glass panels to eliminate conventional opaque headers and configured to receive forces corresponding to the glass panel system.

The present application claims the benefit of U.S. Provisional Patent Application No. 60/347,084, filed Dec. 31, 2001, entitled“Structural Glass Header System” hereby expressly incorporated by reference.

### BACKGROUND OF THE INVENTION

The present invention is directed to glass panel systems, methods of providing glass panel systems, and methods of supporting glass panels, among other various features and objectives presently disclosed. Specifically, the present invention is directed to systems and methods for structurally supporting glass panels and structural systems. Embodiments of the present invention may be especially applicable to systems and methods providing glass panel systems, such as glass shower panels and doors, and in some applications, for new construction or remodeling. The invention may also be particularly applicable to glass panel configurations that provide nearly transparent enclosure of a desired area, and specifically, features may provide use with a variety of glass panels to eliminate conventional opaque construction of glass panel supports.

Conventional glass panel construction typically utilizes upper and lower tracks on which glass panels are hung or are supported. In certain types of conventional glass panel systems, the upper track is configured to guide slidable or rollable hardware that can be coupled to glass panels to allow lateral movement of the panels as described by U.S. Pat. No. 6,023,794, U.S. Pat. No. Des. 255,707, and U.S. Pat. No. 3,653,157, each incorporated by reference herein.

The above-described conventional glass panel construction can be common in both residential and commercial buildings. As such, there is a large and growing demand for such glass panel construction. However, even though glass panel construction has been known for many years and even though there is a large and growing demand for glass panel construction, significant problems with conventional glass panel constructs remain unresolved.

A significant problem with conventional glass panel construction may be that the header or tracks used to support the glass panels are opaque. Conventional headers or tracks used to support the glass panels are typically manufactured from extruded configurations made of metal, opaque plastic, other opaque materials, may be coated with opaque materials, or may generate generally a visual obstruction in the field of view.

Another significant problem with conventional glass panel construction may be that the header or tracks used to support the glass panels are configured with a multiplicity of extensions to act as guides, or support rollable or slidable hardware, or to cover such hardware or the edges of the glass panels themselves. These types of configurations even if made of more transparent materials such as a clear plastic would still generate a visual obstruction in the field of view. Furthermore, prior attempts at glass panel construction, such as those utilizing opaque material or otherwise, may not have fully recognized functional as well as aesthetic features that other materials may provide. Such materials and features, even argued as functional or mechanically similar to previous attempts, may not have been fairly suggested by such attempts where the materials used should provide desirable support and receipt or absorption of forces corresponding to the glass panel construction.

Another significant problem with conventional glass panel construction may be that it is complex requiring headers or tracks having configurations that support or guide rollable or slidable hardware. Such headers or tracks may be prone to malfunction as the tracks or hardware become worn, accumulate debris, or are moved out of alignment.

### SUMMARY OF THE INVENTION

The instant invention addresses each of the above-mentioned problems. Accordingly, a broad object of the invention is to provide glass panel systems that eliminate the opaque materials utilized in conventional glass panel devices.

Another significant object of the invention, in some embodiments, is to provide a glass panel system that eliminates the complexity of conventional glass panel systems that have panels that roll or slide within an extruded track.

Another significant object of the invention can be to provide a glass header providing sufficient support to glass panels in a variety of geometric constructions and being sufficient to support hardware, such as pivot hardware, for pivotally coupled or hingedly coupled glass panels. One goal, therefore, of the present invention is to provide features that adequately receive forces corresponding to the glass panel system.

Naturally, further objects of the inventions are disclosed in other parts of the description and by the Figures provided.

### BRIEF DESCRIPTION OF THE DRAWINGS

FIG. 1a is a top view of a glass panel system embodiment of the present invention.

FIG. 1b is a front view of the glass panel system embodiment of FIG. 1a.

FIG. 2 is a perspective view of a glass panel system embodiment of the present invention having glass panels that are angled with respect to each other.

FIG. 3a is a cross section of an embodiment of a glass panel system embodiment of the invention.

FIG. 3b is a cross section of a second embodiment of a glass panel system embodiment of the invention.

FIGS. 4a-4c depict three examples of how glass panels can be configured and supported by support elements, and may further provide the configuration of corresponding support elements; FIG. 4a is an in-line configuration; FIG. 4b is a multi-angle configuration; FIG. 4c is a configuration of a glass panel and/or support element perpendicular to an adjacent glass panel and/or support element.

FIGS. 5a and 5b shows a cross section of an embodiment of the glass panel system of the invention having features that can be used to fix the glass header to a structure or that can provide additional support of the glass panels with respect to the glass header.

FIG. 6 is a front view of a glass panel system embodiment of the present invention.

FIG. 7 is a front view of a glass panel system embodiment of the present invention.

FIG. 8 is a view of an embodiment of the glass panel system of the invention shown as enclosing a bathing or shower area.

FIG. 9 is a view of an embodiment of the glass panel system of the invention shown as enclosing a bathing or shower area having a hingedly coupled glass panel for ingress and egress from the enclosed area.

FIG. 10 is another view of the embodiment of FIG. 9 shown as enclosing a bathing or shower area and having a hingedly coupled glass panel for ingress and egress from the enclosed area.

### DETAILED DESCRIPTION OF PREFERRED EMBODIMENTS

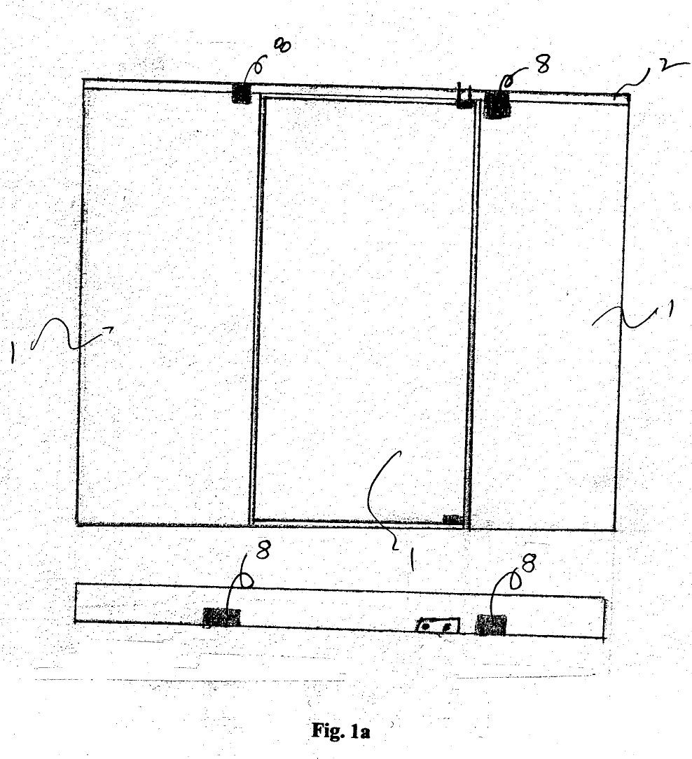

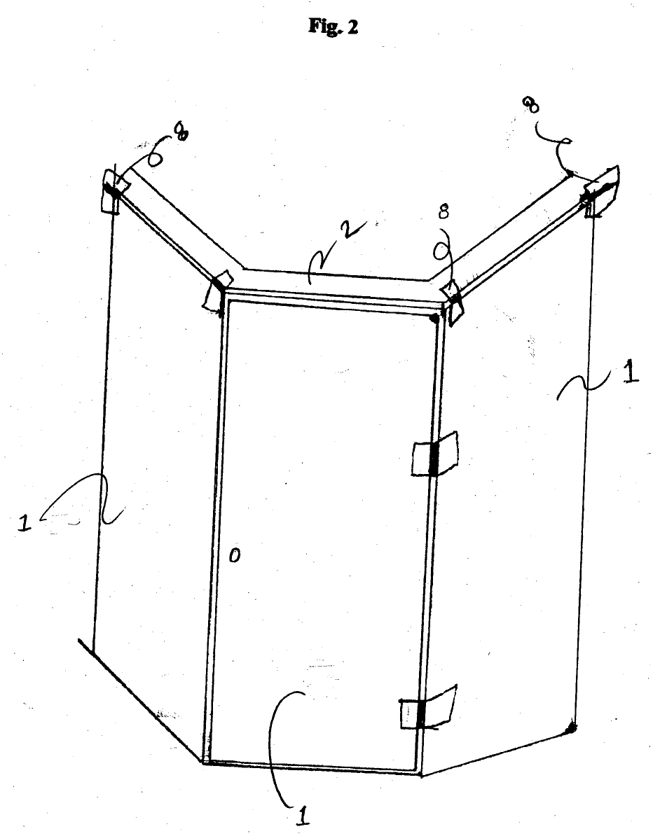

Referring primarily to FIGS. 1a and 1b and FIG. 2, the broad aspects of the invention provide at least one glass panel 1 configured with at least one element 2. The at least one glass panel may be positioned as desired and responsive to the element 2. The at least one element 2 may have a corresponding configuration to a particular configuration of the at least one glass panel. In some embodiments, element(s) 2 may comprise one or a plurality of support elements, or in particular embodiments, a glass header. In some preferred embodiments, element 2 may comprise a glass element or a glass support element, consistent with the present invention. Element 2 may be preferably comprised of glass, enhancing the field of view or transparency to an area enclosed by the at least one glass panel while providing for the receipt of forces as described below.

Throughout the present description, the element(s) 2 may be referred to variously and particularly with regard to some preferred embodiments of the present invention. However, element(s) 2, broadly and in its various embodiments, should be considered as disclosed relative to each such embodiment of the present invention. Although some preferred embodiments may refer and comprise components such as support element(s), a glass element(s), a glass support element(s), or a glass header(s), each such variation are disclosed for the various embodiments.

Accordingly, and as depicted variously throughout the Figures, the at least one element 2, potentially provided as at least one glass element, at least one glass support element (comprising glass in preferred embodiments), at least one support element, or at least one header, may be configured with the at least one glass panel to receive forces corresponding to the glass panel system. It should be understood that the feature of“receiving” forces encompasses the absorption, distribution, or receipt of forces respective of the glass panel system. Further, forces that are corresponding to the glass panel system are forces respective of the glass panel system and elements of the system, such as, but not limited to, forces respective of the configuration of glass panels, forces applied to the system or elements thereof, forces potentially considered to be external of the system, such as a force from a source outside of the system and its components, and forces potentially considered to be internal of the system, such as forces respective of, corresponding to, or as between components (for example, forces created by the weight or configuration of system components). Furthermore, and as described herein, forces applied to a component or as a feature may be considered forces applied directly to a system component, or force transmitted or distributed from system components to other system components such as support features or other structural features.

As described above and variously below, one embodiment of a glass panel system may comprise at least one glass panel 1 and at least one glass element 2 configured with the at least one glass panel to receive forces corresponding to the glass panel system. Other embodiments may particularly provide at least one glass panel 1 and at least one glass support element 2 configured with the at least one glass panel, an adhesive configured with the at least one glass panel and the at least one support element (further described below), such that the at least one glass support element is configured with the at least one glass panel to receive forces corresponding to the glass panel system. Still other glass panel systems are disclosed herein comprises various features as presently described.

In specific regard to the glass panel or panels, each panel can be configured as part of the panel system, such as positioning of the panels, without additional frames responsive to the edges of the panel and be made from about one-half inch thick glass. Naturally, depending on the dimension of the glass panel, and the forces received by the panel(s), such as pressure exerted on the surface of the glass panel, many panel systems of the present invention can comprise glass panel(s) having a thickness from about one-quarter inch to about three-quarters inch, or about one-half inch. The temper of the glass can also be a factor in determining the necessary thickness and when tempered glass is used most embodiments of the invention can comprise glass panels having a thickness of from one-quarter inch to about three-eighths inch. Naturally, any thickness of glass panel can be utilized with the invention to accommodate unusually large panels of glass or an unusually large amount of force being borne by the glass panel(s). In some embodiments of the invention, the glass panels can be tempered, can have color or any portion of the surface can be textured, can be substantially transparent, or opaque.

With reference to the at least one element(s) 2, such as the at least one glass element, the at least one glass support element, the at least one support element, or the at least one glass header, in various embodiments, elements (2) differ from prior systems that position or configure the face of the glass panel(s) substantially vertically to allow the face(s) or surfaces of the glass to receive forces, especially bearing any horizontal force(s), or force(s) having a horizontal component or perpendicular to surfaces of the panels, rather than having such force(s) received by more structurally capable system components such as element 2 of the present invention. Element 2, for example, and by contrast, may have the face(s) of the glass positioned substantially perpendicular to plumb positioning the edge(s) of the element 2 to bear horizontal force(s), or force(s) having a horizontal component, corresponding to the panel system, such as forces having a component substantially perpendicular to a surface of the panel(s), such as a face or edge. Furthermore, forces may be received that correspond to other system components, such as the element 2, at least one hinge (further described below and potentially configured with the panel(s) or element(s) 2), at least one handle, or other system components. For example, and as but one example, forces may be applied to system components directly, such as an external pressure of a hand to a handle of the invention.

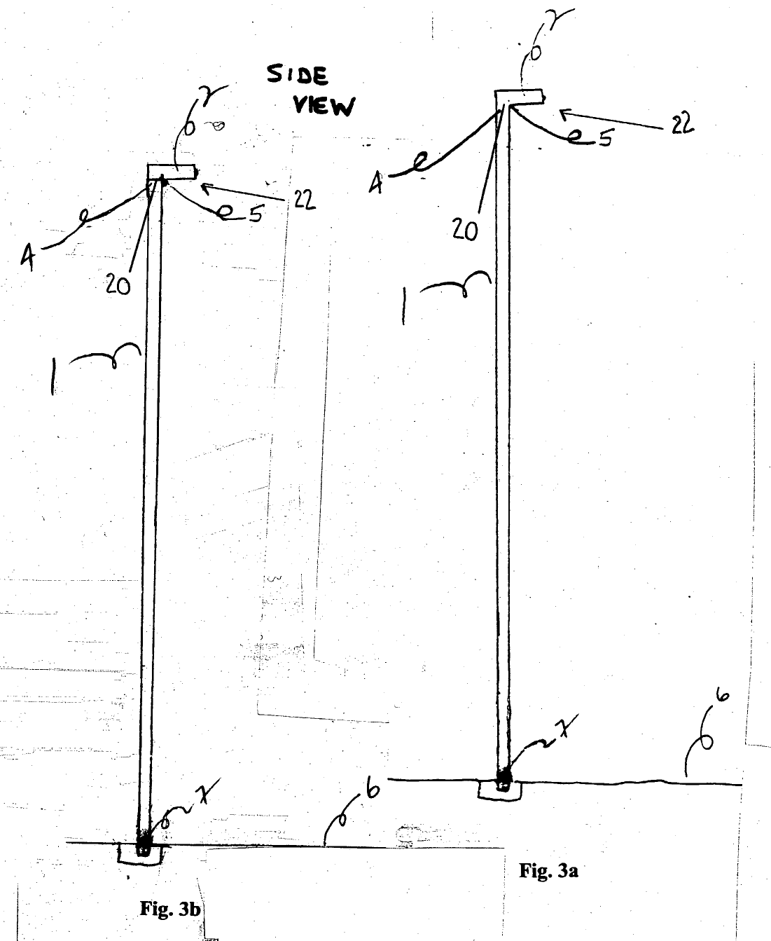

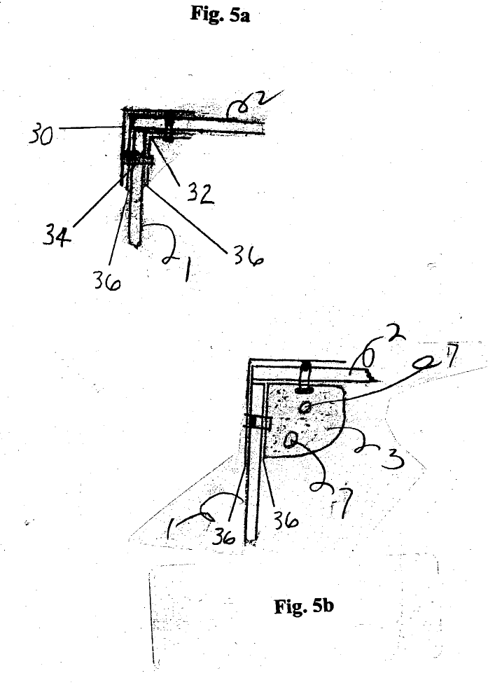

Due to force(s) applied to or otherwise corresponding to the system and received by the at least one element 2, such as the at least one glass element, the at least one support element, the at least one glass support element, or the at least one glass header, these forces can be received and distributed or resisted by the width of the element 2, (all or a portion of the width comprising at least one support surface configured with the panel(s), further described below; embodiments depicted in the cross sections of FIGS. 3a and 3b providing support surfaces 20 as a portion of the width 22 of the element and as may be seen in FIGS. 5a and 5b). The width substantially being greater than the thickness of the glass header in various embodiments (the glass header having a width as useful or desired, and in some embodiments, of about two inches to about four inches, and a thickness in some embodiments of orthogonal to the support surface 20 and of about one-half inch to about three quarters inch), the strength of a glass header 2 can be can be much greater than previous designs, or can be as strong as necessary to receive forces or support the forces or configurations of the glass panel(s) (including fixed panels, or panels that are pivotally coupled together, and including substantially vertical configurations as shown in the Figures and the weight of the panel(s)) responsive thereto.

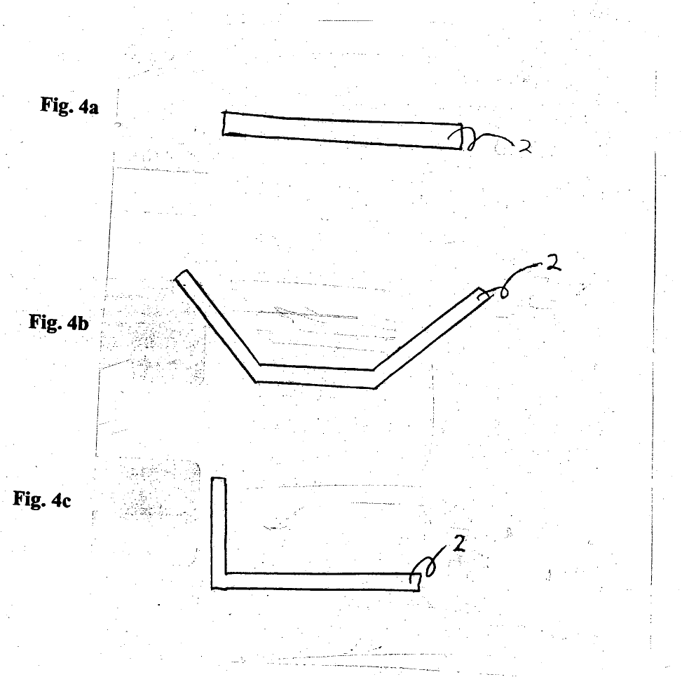

Now referring primarily to FIGS. 4a-4c, certain embodiments of the invention can comprise element(s) 1 such as at least one support element, at least one glass support element, at least one glass element or header 2 that can be configured to support the desired geometry of the glass panel(s) 1. For example, although most any configuration can be made, the at least one element 2 can be of a in-line configuration, have a substantially 90 degree angle (or any angle desired), be configured in a multi-angle configuration for a plurality of panels and support elements, or can have multiple equal or unequal angles, such as equal or un-equal multiple angle configurations (such as may be measured by number of radians or otherwise). In many preferred applications, the element(s) 2 may be about two inches to four inches in width and about one-half inch to about three-quarters inch thick tempered glass. Understandably, the element(s) 2 can be dimensioned as desired and configured in any number to be suitable in many and various applications.

Now referring primarily to FIGS. 5a and 5b, certain embodiments of the invention provide retention device 3, such as mechanical hardware or alternatively or in combination adhesive that is configured with the element 2 and retentively connects the glass header to a structural or supporting structure, such as a wall or support member (see for example the hardware shown in FIG. 5b). The retention device is installed to the structural or supporting surface with mechanical hardware 7 such as bolts or screws or can be installed with adhesive, or otherwise, as necessary or desired. The retention may be configured with a structure such as a frame, jam, or stud. The element 2 can then be joined to the hardware 3, and in some embodiments, configured so that the support surface or face of the element 2 is configured substantially in a horizontal configuration (substantially perpendicular to the glass panels the element(s) or glass header(s) supports) while one edge of the element or glass header 1 is oriented substantially vertically.

Glass panels 1 can be then supported by the element(s) 2 such as a glass header in a substantially vertical configuration, as shown variously in the Figures and with reference to FIGS. 3. The glass panels 1 and the elements 2 may be configured with an adhesive 4 to facilitate adhesive configuring of the components and added structural support. The edges of the glass panels 1 can be made responsive to the face or the edge of the glass header with the adhesive 4 (which can comprise an ultraviolet protection material, such as to prevent discoloration, and may be substantially transparent). The glass panel(s) and element(s) 1 can be further configured with a bead 5, and in some embodiments a gusset, along the angle formed by the configuration or joining, in some embodiments, of the glass panel 1 with the element or glass header 2. The gusset or bead can with respect to certain embodiments of the invention be a clear silicone rubber, adhesive, ultraviolet protection material, substantially transparent, or the like.

The glass panels, in some embodiments, may be configurable with a recess or other floor component. In some preferred embodiments, and as shown in FIGS. 3, the edge(s) of the glass panel(s) 1 opposite that edge(s) configured or otherwise supported by the element 1 or glass header can be supported by floor surface 6, either by providing a recess 7 in the floor surface into which the glass panel(s) can be inserted, such as insertably configured with the recess, or by building up the floor surface on either side of the glass panel, as desired. As to those embodiments of the invention in which the glass panel(s) are inserted into a recess 7 in the floor surface 6, black mason tar, rubberized black coating, or black paint can be applied to the recessed surfaces of the glass panels 1 to obviate the transmission of light of the recess, obscuring the features of the recess from view, or to seal the recess 7 from moisture, such as providing the glass panel(s) as sealably configured with the recess.

Now referring to FIGS. 1 and 2 and FIG. 5, additional hardware, such as at least one support 8, such as in some embodiments provided as configured with the at least one glass panel and the at least one element 1, can provide additional strength in addition to the adhesive 4, or bead 5 discussed above. Some preferred embodiments comprise at least one clip or glass support. With respect to some embodiments of the invention, the support 8 can comprise a 90 degree glass support as shown in FIG. 5a, but could also be configured as required, or desired, to provide additional support of glass panels 1 that are not configured perpendicular to the glass header. One embodiment of the present invention may provide two glass support elements. The first glass support element 30, is configured along an outer portion of the glass panel(s) and the element or glass element 2. A second glass element 32 is configured along an inner portion of the glass panel(s) and the element or glass element 2. Furthermore, and as shown, hardware access may be configured through the glass supports 8, such as elements 30 and 32 as shown, the element(s) 2 such as glass element(s) previously described, and the glass panel(s). Further hardware may be configured with the glass support(s) 8 and the panel(s) and the element(s) 1, such as grommets 34 and gaskets 36.

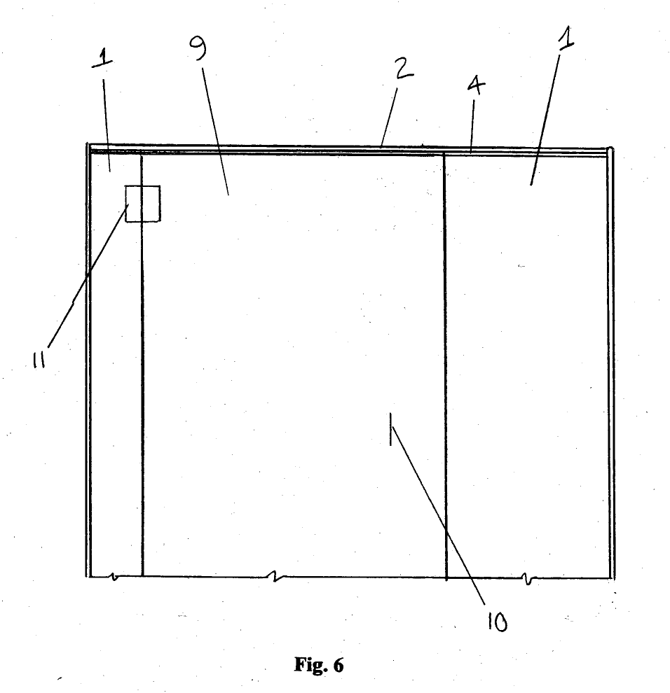

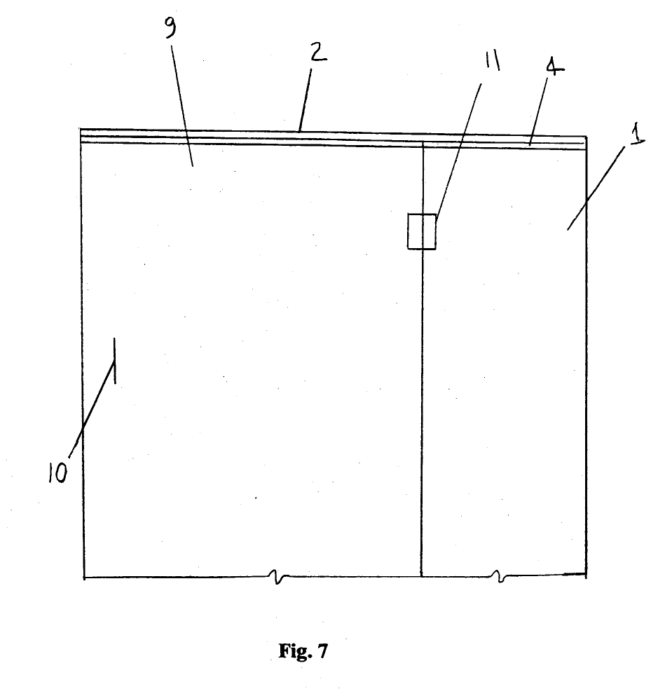

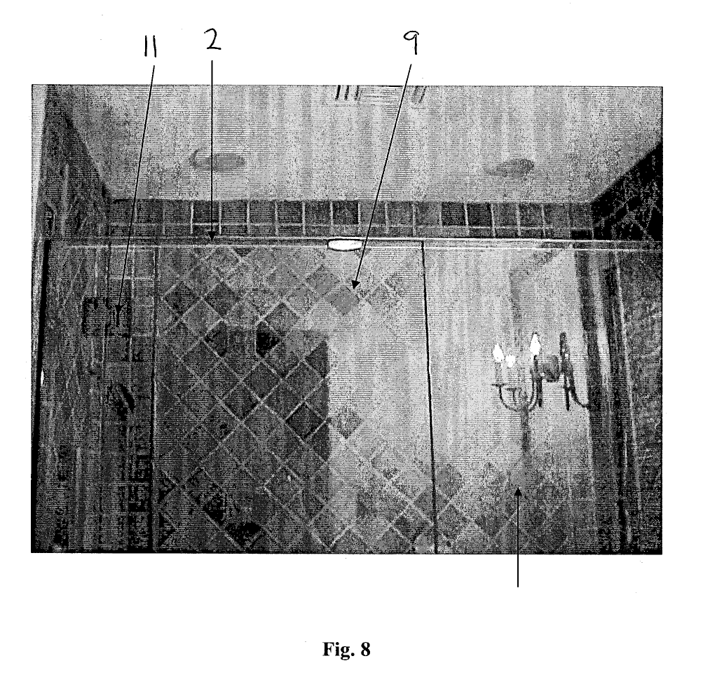

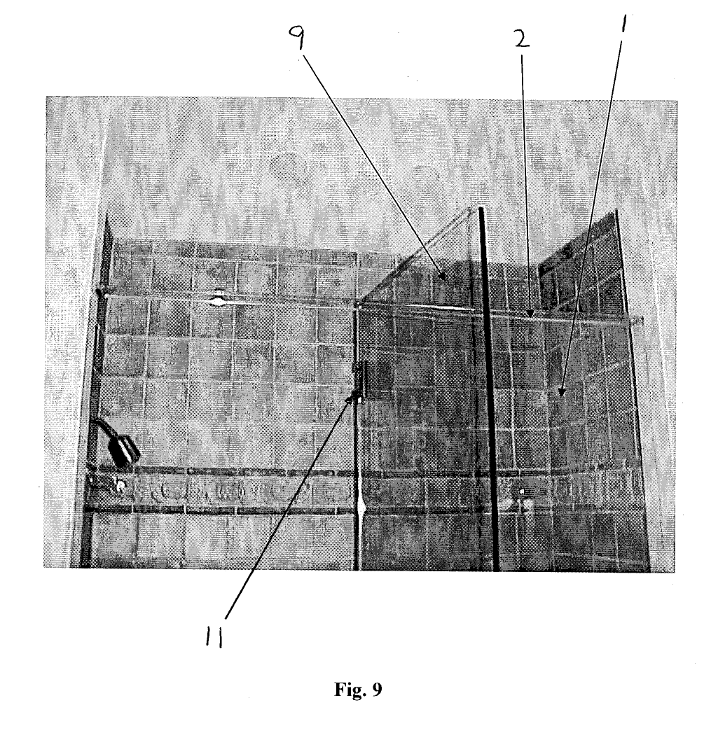

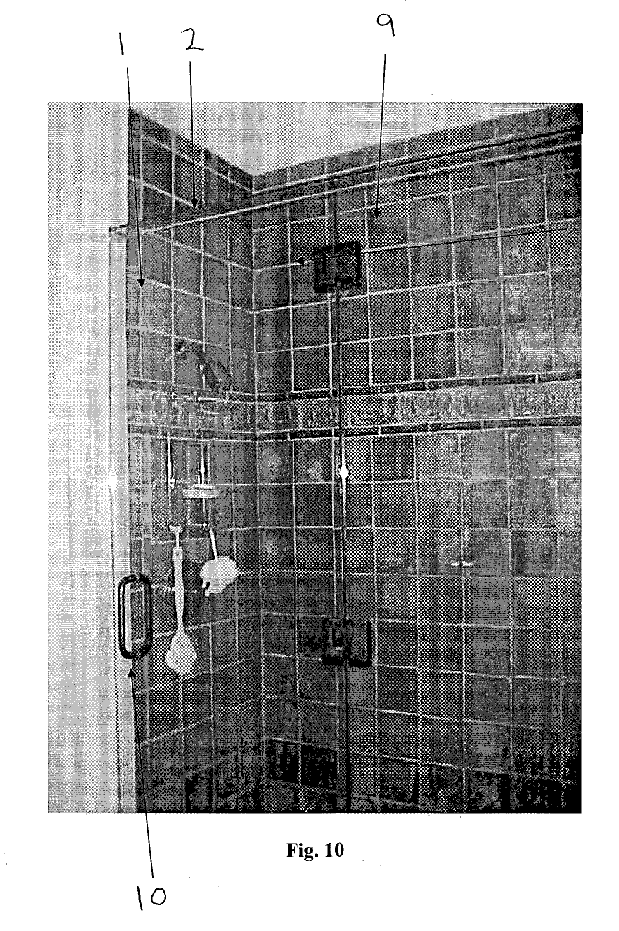

Again referring to FIG. 1 and in reference to FIGS. 6-10, the element 2 such as a glass element can further provide support for pivot hardware 11, such as a hinge, that is pivotally configured with the at least one element 2 and the at least one glass panel 1. This allows for some embodiments of the invention to further incorporate glass panel(s) 1 that are pivotally configured with the at least one glass element rotate about the pivot axis of the hardware to provide doors for ingress and egress from the area enclosed by the glass panels 1.

Now referring primarily to FIGS. 6-10, an embodiment of the invention is shown that encloses a bathing or shower area. As can be understood, the invention when used for this application can comprise at least one glass panel 1 supported by an element 2 such as glass header. This embodiment of the invention can further comprise a hingedly coupled glass panel 9 that allows ingress and egress from the bathing or shower area. As can be understood from the Figures, the glass panels 1 have been configured with the glass header 2 by adhesive 4 and a bead or gusset 5 of clear silicone rubber. The bottom edges of the glass panels 1 have been fitted into a recess in the floor surface. As shown in FIGS. 6, 7, and 10, a handle 10 has been installed to the hingedly coupled glass panel 9 for the convenience of the user. In this embodiment of the invention, no support elements 8, such as glass supports or clips 8 have been utilized. As shown the use of glass panel(s) with a glass element such as glass header 2 along with the pivot hardware 11 minimizes the use of opaque material in the field of vision.

Methods of manufacture or construction of glass panel systems are also disclosed as embodiments of the present invention. Accordingly, one embodiment may provide, consistent with the features previously described, a method of providing a glass panel system, comprising the steps of providing at least one glass panel, providing at least one glass support element, configuring an adhesive with the at least one glass panel and the at least one glass support element, and configuring the at least one glass support element with the at least one glass panel to receive forces corresponding to the glass panel system. Numerous steps are also disclosed and claimed consistent with the features previously described and the appended claims.

Methods of providing support to at least one glass panel are disclosed, and in some embodiments, comprise the steps of configuring at least one glass support element with the at least one glass panel, configuring an adhesive with the at least one glass panel and the at least one glass support element, and receiving forces by the at least one glass support element corresponding to said glass panel system. Other embodiments may comprise configuring at least one glass element with the at least one glass panel to receive forces corresponding to the glass panel system and receiving forces having at least a horizontal component substantially perpendicular to a surface of the at least one glass panel. Glass panel systems may be accordingly produced with the methods and processes of the present invention. Again, numerous steps are also disclosed and claimed consistent with the features previously described and the appended claims.

As can be easily understood from the foregoing, the basic concepts of the present invention may be embodied in a variety of ways. It involves methods, processes, and techniques as well as elements, devices, apparatus, assemblies, and systems to accomplish the various disclosed techniques. In this application, the methods, processes, and techniques are disclosed as part of the results shown to be achieved by the various elements, devices, apparatus, assemblies, and systems described and as steps which are inherent to utilization. They are simply the natural result of utilizing the elements, devices, apparatus, assemblies, and systems as intended and described. In addition, while elements, devices, apparatus, assemblies, and systems are disclosed, it should be understood that these not only accomplish certain methods but also can be varied in a number of ways. Importantly, as to all of the foregoing, all of these facets should be understood to be encompassed by this disclosure.

Further, each of the various elements of the invention and claims may also be achieved in a variety of manners. This disclosure should be understood to encompass each such variation, be it a variation of an embodiment of any apparatus embodiment, a method or process embodiment, or even merely a variation of any element of these. Particularly, it should be understood that as the disclosure relates to elements of the invention, the words for each element may be expressed by equivalent apparatus terms or method terms—even if only the function or result is the same. Such equivalent, broader, or even more generic terms should be considered encompassed by the description of each element or action. Such terms can be substituted where desired to make explicit the implicitly broad coverage to which this invention is entitled. As but one example, it should be understood that all functions or actions may be expressed as a means for functioning or taking that action or as an element which causes that function or action. Similarly, each physical element disclosed should be understood to encompass a disclosure of the action of which that physical element facilitates. Regarding this last aspect, as but one example, the disclosure of a“support element” should be understood to encompass disclosure of the act of“supporting”—whether explicitly discussed or not—and, conversely, were there effectively disclosure of the act of “supporting”, such a disclosure should be understood to encompass disclosure of a “support” and even a “means for supporting.” Such changes and alternative terms are to be understood to be explicitly included in the description.

Any acts of law, statutes, regulations, or rules mentioned in this application for patent; or patents, publications, or other references mentioned in this application for patent are hereby incorporated by reference. In addition, as to each term used it should be understood that unless its utilization in this application is inconsistent with such interpretation, common dictionary definitions should be understood as incorporated for each term and all definitions, alternative terms, and synonyms such as contained in the Random House Webster's Unabridged Dictionary, second edition are hereby incorporated by reference. Finally, all references listed in the information statement filed with the application are hereby incorporated by reference. However, as to each of the above, to the extent that such information or statements incorporated by reference might be considered inconsistent with the patenting of this/these invention(s) such statements are expressly not to be considered as made by the applicant(s).

Further, if or when used, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps. Such terms should be interpreted in their most expansive form so as to afford the applicant the broadest coverage legally permissible.

Any claims set forth at any time are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

What is claimed is:

1. A glass panel system, comprising:
at least one glass panel; and
at least one glass element configured with said at least one glass panel to receive forces corresponding to said glass panel system.

2. A glass panel system as described in claim 1 wherein said at least one glass element is configured with said at least one glass panel to support at least the weight of said at least one glass panel.

3. A glass panel system as described in claim 1 wherein said at least one glass element is configured with said at least one glass panel to receive forces having at least a component substantially perpendicular to a surface of said at least one glass panel.

4. A glass panel system as described in claim 3 wherein said at least one glass element is configured with said at least one glass panel to receive forces having at least a component substantially perpendicular to a face of said at least one glass panel.

5. A glass panel system as described in claim 3 wherein said at least one glass element is configured with said at least one glass panel to receive forces having at least a component substantially perpendicular to an edge of said at least one glass panel.

6. A glass panel system as described in claim 1 wherein said at least one glass element is configured with said at least one glass panel to receive forces corresponding to said at least one glass element.

7. A glass panel system as described in claim 1 further comprising at least one hinge configured with said at least one glass panel and wherein said at least one glass element is configured with said at least one glass panel to receive forces corresponding to said at least one hinge.

8. A glass panel system as described in claim 1 further comprising at least one hinge configured with said at least one glass element and wherein said at least one glass element is configured with said at least one glass panel to receive forces corresponding to said at least one hinge.

9. A glass panel system as described in claim 1 further comprising a handle configured with said at least one glass panel and wherein said at least one glass element is configured with said at least one glass panel to receive forces corresponding to said handle.

10. A glass panel system as described in claim 1 wherein said at least one glass element comprises at least one support surface.

11. A glass panel system as described in claim 10 wherein said support surface comprises at least a portion of a width of said at least one glass element configured to receive said forces corresponding to said glass panel system.

12. A glass panel system as described in claim 10 wherein said support surface is configured in a substantially horizontal configuration.

13. A glass panel system as described in claim 1 wherein said at least one glass element is configured with said at least one glass panel to support a substantially vertical configuration of said at least one glass panel.

14. A glass panel system as described in claim 13 wherein said at least one glass panel is configured in a substantially vertical configuration.

15. A glass panel system as described in claim 14 wherein said said at least one glass element comprises at least one support surface configured substantially perpendicular to a substantially vertical configuration of said at least one glass panel.

16. A glass panel system as described in claim 15 wherein said at least one support surface is configured to receive said forces corresponding to said glass panel system.

17. A glass panel system as described in claim 16 wherein said at least one support surface comprises at least a portion of a width of said at least one glass element.

18. A glass panel system as described in claim 10 wherein said glass panel is configured in a substantially vertical configuration and wherein said at least one support surface extends substantially perpendicular to said vertical configuration.

19. A glass panel system as described in claim 18 wherein said at least one support surface is configured with said said at least one glass panel to form a cornice.

20. A glass panel system as described in claim 19 wherein said at least one support surface extends substantially perpendicular in two directions to said vertical configuration.

21. A glass panel system as described in claim 10 wherein said at least one support surface comprises at least a portion of a width of said said at least one glass element.

22. A glass panel system as described in claim 21 wherein said width is about two inches to about four inches.

23. A glass panel system as described in claim 10 wherein said at least one glass element comprises a thickness orthogonal to said at least one support surface of about one-half inch to about three-quarters inch.

24. A glass panel system as described in claim 1 wherein said at least one glass element comprises a width of about two inches to about four inches.

25. A glass panel system as described in claim 1 wherein said at least one glass element comprises a thickness of about one-half inch to about three-quarters inch.

26. A glass panel system as described in claim 1 wherein said at least one glass panel comprises a thickness of about one-half inch.

27. A glass panel system as described in claim 1 wherein said at least one glass panel comprises a thickness of about one-quarter inch to about three-quarters inch.

28. A glass panel system as described in claim 1 wherein said at least one glass panel comprises a thickness of about one-quarter inch to about three-eighths inch.

29. A glass panel system as described in claim 1 wherein said at least one glass element comprises tempered glass.

30. A glass panel system as described in claim 1 wherein said at least one glass element comprises opaque glass.

31. A glass panel system as described in claim 1 wherein said at least one glass element comprises textured glass.

32. A glass panel system as described in claim 1 wherein said at least one glass element comprises substantially transparent glass.

33. A glass panel system as described in claim 1 wherein said at least one glass element comprises colored glass.

34. A glass panel system as described in claim 1 wherein said at least one glass panel comprises tempered glass.

35. A glass panel system as described in claim 1 wherein said at least one glass panel comprises substantially a material selected from the group consisting of opaque glass, textured glass, colored glass, and substantially transparent glass.

36. A glass panel system as described in claim 1 wherein said at least one glass element comprises a header.

37. A glass panel system as described in claim 1 further comprising at least one retention configured with said said at least one glass element.

38. A glass panel system as described in claim 37 wherein said at least one retention is configured with a structure.

39. A glass panel system as described in claim 38 wherein said structure comprises a wall.

40. A glass panel system as described in claim 38 wherein said structure comprises a support member.

41. A glass panel system as described in claim 38 wherein said structure comprises a structure selected from the group consisting of a frame, jam, and stud.

42. A glass panel system as described in claim 37 wherein said at least one retention is configured with said said at least one glass element to retentively connect said at least one glass element with a structure.

43. A glass panel system as described in claim 37 wherein said at least one retention device comprises mechanical hardware.

44. A glass panel system as described in claim 37 wherein said at least one retention device comprises adhesive.

45. A glass panel system as described in claim 1 further comprising an adhesive configured with said at least one glass panel and said at least one glass element.

46. A glass panel system as described in claim 45 wherein said at least one glass panel is adhesively configured with said at least one glass element.

47. A glass panel system as described in claim 46 wherein an edge of said at least one glass panel is adhesively configured with said at least one glass element.

48. A glass panel system as described in claim 46 wherein said at least one glass element comprises a support surface and wherein an edge of said at least one glass panel is adhesively configured with said support surface.

49. A glass panel system as described in claim 45 wherein said adhesive comprises an ultraviolet protection material.

50. A glass panel system as described in claim 45 wherein said adhesive is substantially transparent.

51. A glass panel system as described in claim 45 further comprising a bead configured with said at least one glass panel and said at least one glass element.

52. A glass panel system as described in claim 51 wherein said bead is configured along an angle formed by the configuration of said at least one glass panel and said at least one glass element.

53. A glass panel system as described in claim 52 wherein said bead is configured along an angle of about ninety degrees formed by the configuration of said at least one glass panel and said at least one glass element.

54. A glass panel system as described in claim 51 wherein said bead comprises clear silicone rubber.

55. A glass panel system as described in claim 51 wherein said bead comprises an adhesive.

56. A glass panel system as described in claim 51 wherein said bead comprises an ultraviolet protection material.

57. A glass panel system as described in claim 51 wherein said bead is substantially transparent.

58. A glass panel system as described in claim 1 wherein said at least one glass panel is configurable with a recess of a floor.

59. A glass panel system as described in claim 58 wherein said at least one glass panel is insertably configured with said recess.

60. A glass panel system as described in claim 58 wherein said at least one glass panel is sealably configured with said recess.

61. A glass panel system as described in claim 58 wherein said at least one glass panel is configured with said recess to prevent light transmission of said recess.

62. A glass panel system as described in claim 1 further comprising at least one support configured with said at least one of said glass panel and said at least one glass element.

63. A glass panel system as described in claim 62 wherein said at least one support comprises at least one clip.

64. A glass panel system as described in claim 62 wherein said at least one support comprises at least one glass support.

65. A glass panel system as described in claim 64 wherein said at least one glass support comprises a substantially ninety-degree glass support.

66. A glass panel system as described in claims 64 or 65 wherein said at least one glass support comprises two glass support elements, a first glass support element configured along an outer portion of said at least one glass panel and said at least one glass element, and a second glass support element configured along an inner portion of said at least one glass panel and said at least one glass element.

67. A glass panel system as described in claim 64 further comprising at least one hardware access configured through said at least one glass support and through said at least one glass panel.

68. A glass panel system as described in claim 64 further comprising at least one hardware access configured through said at least one glass support and through said at least one glass element.

69. A glass panel system as described in claim 67 further comprising at least one grommet configured with said at least one glass support and said at least one glass panel.

70. A glass panel system as described in claim 68 further comprising at least one grommet configured with said at least one glass support and said at least one glass element.

71. A glass panel system as described in claim 62 further comprising a gasket configured with said glass support and said at least one glass panel.

72. A glass panel system as described in claim 62 further comprising a gasket configured with said glass support and said at least one glass element.

73. A glass panel system as described in claim 1 wherein said at least one glass panel is pivotally configured with said at least one glass element.

74. A glass panel system as described in claim 73 further comprising a hinge pivotally configured with said at least one glass panel and said at least one glass element.

75. A glass panel system as described in claim 1 wherein said at least one glass element comprises a plurality of glass elements configured in an in-line configuration.

76. A glass panel system as described in claim 1 wherein said at least one glass element comprises a plurality of glass elements configured in a multiple angle configuration.

77. A glass panel system as described in claim 76 wherein said multiple angle configuration comprises an equal multiple angle configuration.

78. A glass panel system as described in claim 76 wherein said multiple angle configuration comprises a non-equal multiple angle configuration.

79. A glass panel system as described in claim 1 wherein said at least one glass element comprises a plurality of glass elements and wherein at least one of said plurality of glass elements is configured substantially perpendicular to at least one adjacent glass element.

80. A glass panel system as described in claims 75, 76, or 77 wherein said at least one glass panel comprises a plurality of glass panels and wherein each of said glass panels is configured in a corresponding configuration to one of said plurality of glass elements.

81. A glass panel system, comprising:
at least one glass panel;
at least one glass support element configured with said at least one glass panel; and
an adhesive configured with said at least one glass panel and said at least one support element,
wherein said at least one glass support element is configured with said at least one glass panel to receive forces corresponding to said glass panel system.

82. A glass panel system as described in claim 81 wherein said at least one glass support element is configured with said at least one glass panel to receive forces having at least a component substantially perpendicular to a surface of said at least one glass panel.

83. A glass panel system as described in claim 81 wherein said at least one glass support element comprises at least one support surface.

84. A glass panel system as described in claim 83 wherein said support surface comprises at least a portion of a width of said at least one glass support element configured to receive said forces corresponding to said glass panel system.

85. A glass panel system as described in claim 83 wherein said support surface is configured in a substantially horizontal configuration.

86. A glass panel system as described in claim 81 wherein said glass support element is configured with said at least one glass panel to support a substantially vertical configuration of said at least one glass panel.

87. A glass panel system as described in claim 86 wherein said at least one glass panel is configured in a substantially vertical configuration.

88. A glass panel system as described in claim 87 wherein said at least one glass support element comprises at least one support surface configured substantially perpendicular to a substantially vertical configuration of said at least one glass panel.

89. A glass panel system as described in claim 88 wherein said at least one support surface is configured to receive said forces corresponding to said glass panel system.

90. A glass panel system as described in claim 89 wherein said at least one support surface comprises at least a portion of a width of said at least one glass support element.

91. A glass panel system as described in claim 83 wherein said at least one support surface comprises at least a portion of a width of said glass support element.

92. A glass panel system as described in claim 91 wherein said width is about two inches to about four inches.

93. A glass panel system as described in claim 83 wherein said at least one glass support element comprises a thickness orthogonal to said at least one support surface of about one-half inch to about three-quarters inch.

94. A glass panel system as described in claim 81 wherein said at least one glass support element comprises a width of about two inches to about four inches.

95. A glass panel system as described in claim 81 wherein said at least one glass support element comprises a thickness of about one-half inch to about three-quarters inch.

96. A glass panel system as described in claim 81 wherein said at least one glass panel comprises a thickness of about one-half inch.

97. A glass panel system as described in claim 81 wherein said at least one glass panel comprises a thickness of about one-quarter inch to about three-quarters inch.

98. A glass panel system as described in claim 81 wherein said at least one glass panel comprises a thickness of about one-quarter inch to about three-eighths inch.

99. A glass panel system as described in claim 81 wherein said at least one glass support element comprises tempered glass.

100. A glass panel system as described in claim 81 wherein said at least one glass support element comprises glass selected from the group consisting of opaque glass, textured glass, substantially transparent glass, and colored glass.

101. A glass panel system as described in claim 81 wherein said at least one glass panel comprises tempered glass.

102. A glass panel system as described in claim 81 wherein said at least one glass panel comprises substantially a material selected from the group consisting of opaque glass, textured glass, colored glass, and substantially transparent glass.

103. A glass panel system as described in claim 81 wherein said adhesive comprises an ultraviolet protection material.

104. A glass panel system as described in claim 81 wherein said adhesive is substantially transparent.

105. A glass panel system as described in claim 81 further comprising a bead configured with said at least one glass panel and said at least one glass support element.

106. A glass panel system as described in claim 105 wherein said bead comprises a material selected from the group consisting of clear silicone rubber, an adhesive, an ultraviolet protection material, a substantially transparent material.

107. A glass panel system as described in claim 81 wherein said at least one glass panel is configurable with a recess of a floor.

108. A glass panel system as described in claim 107 wherein said at least one glass panel is insertably configured with said recess.

109. A glass panel system as described in claim 107 wherein said at least one glass panel is sealably configured with said recess.

110. A glass panel system as described in claim 107 wherein said at least one glass panel is configured with said recess to prevent light transmission of said recess.

111. A glass panel system as described in claim 1 further comprising at least one support configured with said at least one of said glass panel and said at least one glass support element.

112. A glass panel system as described in claim 111 wherein said at least one support comprises at least one clip.

113. A glass panel system as described in claim 111 wherein said at least one support comprises at least one glass support.

114. A glass panel system as described in claim 113 wherein said at least one glass support comprises a substantially ninety-degree glass support.

115. A glass panel system as described in claims 113 or 114 wherein said at least one glass support comprises two glass support elements, a first glass support element configured along an outer portion of said at least one glass panel and said at least one glass element, and a second glass support element configured along an inner portion of said at least one glass panel and said at least one glass support element.

116. A glass panel system as described in claim 113 further comprising at least one hardware access configured through said at least one glass support and through said at least one glass panel.

117. A glass panel system as described in claim 113 further comprising at least one hardware access configured through said at least one glass support and through said at least one glass support element.

118. A method of providing a glass panel system, comprising the steps of:
providing at least one glass panel;
providing at least one glass support element;
configuring an adhesive with said at least one glass panel and said at least one glass support element; and
configuring said at least one glass support element with said at least one glass panel to receive forces corresponding to said glass panel system.

119. A method of providing a glass panel system as described in claim 118 wherein said step of configuring said at least one glass support element with said at least one glass panel comprises configuring said at least one glass support element with said at least one glass panel to receive forces having at least a component substantially perpendicular to a surface of said at least one glass panel.

120. A method of providing a glass panel system as described in claim 118 wherein said step of providing at least one glass support element comprises providing at least one support surface of said at least one glass support element.

121. A method of providing a glass panel system as described in claim 118 wherein providing at least one support surface comprises providing a portion of a width of said at least one glass support element configured to receive said forces.

122. A method of providing a glass panel system as described in claim 118 further comprising the step of substantially horizontally configuring said at least one support surface.

123. A method of providing a glass panel system as described in claim 118 wherein said step of configuring said at least one glass support element with said at least one glass panel comprises configuring said at least one glass support element with said at least one glass panel to support a substantially vertical configuration of said at least one glass panel.

124. A method of providing a glass panel system as described in claim 118 further comprising the step of configuring said at least one glass panel in a substantially vertical configuration.

125. A method of providing a glass panel system as described in claim 124 further comprising providing at least one support surface of said at least one glass support element and configuring said at least one support surface substantially perpendicular to a substantially vertical configuration of said at least one glass panel.

126. A method of providing a glass panel system as described in claim 125 further comprising configuring said at least one support surface to receive said forces corresponding to said glass panel system.

127. A method of providing a glass panel system as described in claim 126 wherein providing at least one support surface comprises providing at least a portion of a width of said at least one glass support element.

128. A method of providing a glass panel system as described in claim 120 wherein providing at least one support surface comprises providing a portion of a width of said at least one glass support element configured to receive said forces.

129. A method of providing a glass panel system as described in claim 121 wherein providing a width comprises providing a width of about two inches to about four inches.

130. A method of providing a glass panel system as described in claim 120 wherein step of providing at least one glass support element comprises providing at least one glass support element comprising a thickness orthogonal to said at least one support surface of about one-half inch to about three-quarters inch.

131. A method of providing a glass panel system as described in claim 118 wherein step of providing at least one glass support element comprises providing at least one glass support element comprising a width of about two inches to about four inches.

132. A method of providing a glass panel system as described in claim 118 wherein step of providing at least one glass support element comprises providing at least one glass support element comprising a thickness of about one-half inch to about three-quarters inch.

133. A method of providing a glass panel system as described in claim 118 wherein said step of providing at least one glass panel comprises providing at least one glass panel comprising a thickness of about one-half inch.

134. A method of providing a glass panel system as described in claim 118 wherein said step of providing at least one glass panel comprises providing at least one glass panel comprising a thickness of about one-quarter inch to about three-quarters inch.

135. A method of providing a glass panel system as described in claim 118 wherein said step of providing at least one glass panel comprises providing at least one glass panel comprising a thickness of about one-quarter inch to about three-eighths inch.

136. A method of providing a glass panel system as described in claim 118 wherein providing at least one glass support element comprises providing at least one tempered glass support element.

137. A method of providing a glass panel system as described in claim 118 wherein providing at least one glass support element comprises providing at least one glass support element comprising glass selected from the group consisting of opaque glass, textured glass, substantially transparent glass, and colored glass.

138. A method of providing a glass panel system as described in claim 118 wherein providing at least one glass panel comprises providing at least one glass panel comprising tempered glass.

139. A method of providing a glass panel system as described in claim 118 wherein providing at least one glass panel comprises providing at least one glass panel comprising substantially a material selected from the group consisting of opaque glass, textured glass, colored glass, and substantially transparent glass.

140. A method of providing a glass panel system as described in claim 118 wherein configuring an adhesive comprises configuring an adhesive comprising an ultraviolet protection material.

141. A method of providing a glass panel system as described in claim 118 wherein configuring an adhesive comprises configuring a substantially transparent adhesive.

142. A method of providing a glass panel system as described in claim 118 further comprising configuring a bead with said at least one glass panel and said at least one support element.

143. A method of providing a glass panel system as described in claim 142 wherein configuring a bead comprises configuring a bead of a material selected from the group consisting of clear silicone rubber, an adhesive, an ultraviolet protection material, and a substantially transparent material.

144. A method of providing a glass panel system as described in claim 118 further comprising configuring said at least one glass panel with a recess of a floor.

145. A method of providing a glass panel system as described in claim 144 wherein configuring said at least one glass panel comprises insertably configuring said at least one glass panel.

146. A method of providing a glass panel system as described in claim 144 wherein configuring said at least one glass panel comprises sealably configuring said at least one glass panel.

147. A method of providing a glass panel system as described in claim 144 wherein configuring said at least one glass panel comprises configuring said at least one glass panel with said recess to prevent light transmission of said recess.

148. A method of providing a glass panel system as described in claim 118 further comprising the steps of providing at least one support and configuring said at least one support with said at least one of said glass panel and said at least one glass support element.

149. A method of providing a glass panel system as described in claim 148 wherein providing at least one support comprises providing at least one clip.

150. A method of providing a glass panel system as described in claim 148 wherein providing at least one support comprises providing at least one glass support.

151. A method of providing a glass panel system as described in claim 150 wherein providing at least one glass support comprises providing a substantially ninety-degree glass support.

152. A method of providing a glass panel system as described in claims 150 or 151 wherein providing at least one glass support comprises providing two glass support elements and further comprising the steps of configuring a first glass support element along an outer portion of said at least one glass panel and said at least one glass support element and configuring a second glass support element along an inner portion of said at least one glass panel and said at least one glass support element.

153. A method of providing a glass panel system as described in claim 152 further comprising the step of providing at least one hardware access configured through said two glass support elements and through said at least one glass panel.

154. A method of providing a glass panel system as described in claim 152 further comprising the step of providing at least one hardware access configured through said two glass support elements and through said at least one glass element.

155. A glass panel system produced according to the process of claim 118.

156. A method of providing support to at least one glass panel, comprising the steps of:
configuring at least one glass support element with said at least one glass panel;
configuring an adhesive with said at least one glass panel and said at least one glass support element; and
receiving forces by said at least one glass support element corresponding to said glass panel system.

157. A method of providing support to at least one glass panel as described in claim 156 wherein receiving forces comprises receiving forces having at least a component substantially perpendicular to a surface of said at least one glass panel.

158. A method of providing support to at least one glass panel as described in claim 156 wherein configuring at least one glass support element comprises substantially horizontally configuring said at least one glass support element.

159. A method of providing support to at least one glass panel as described in claim 156 further comprising supporting said at least one glass panel in a substantially vertical configuration.

160. A method of providing support to at least one glass panel as described in claim 159 wherein configuring at least one glass support element comprises configuring at least one glass support element substantially perpendicular to a substantially vertical configuration of said at least one glass panel.

161. A method of providing support to at least one glass panel as described in claim 156 further comprising configuring a bead with said at least one glass panel and said at least one glass support element.

162. A method of providing support to at least one glass panel as described in claim 156 further comprising configuring said at least one glass panel with a recess of a floor.

163. A method of providing support to at least one glass panel as described in claim 162 wherein configuring said at least one glass panel comprises insertably configuring said at least one glass panel.

164. A method of providing support to at least one glass panel as described in claim 162 wherein configuring said at least one glass panel comprises sealably configuring said at least one glass panel.

165. A method of providing support to at least one glass panel as described in claim 156 further comprising the steps of configuring at least one support with said at least one of said glass panel and said at least one glass support element.

166. A method of providing support to at least one glass panel as described in claim 156 further comprising the steps of configuring a support along an outer portion of said at least one glass panel and said at least one glass support element and configuring a second support along an inner portion of said at least one glass panel and said at least one glass support element.

167. A method of providing support to at least one glass panel, comprising the steps of:
configuring at least one glass element with said at least one glass panel to receive forces
corresponding to said glass panel system; and
receiving forces having at least a horizontal component substantially perpendicular to a surface of said at least one glass panel.
